(19) United States
(12) Patent Application Publication
(10) Pub. No.: US 2026/0138076 A1
(43) Pub. Date: May 21, 2026

(54) VOLATILE ORGANIC EXHAUST GAS PURIFICATION TREATMENT DEVICE AND PURIFICATION TREATMENT METHOD THEREOF

(71) Applicant: JG ENVIRONMENTAL TECHNOLOGY CO., LTD, Taoyuan City (TW)

(72) Inventors: FENG-TANG CHANG, Taoyuan City (TW); CHIEN-LIANG HWANG, Taoyuan City (TW); SHAO-CHIEN CHANG, Taoyuan City (TW)

(73) Assignee: JG ENVIRONMENTAL TECHNOLOGY CO., LTD, Taoyuan City (TW)

(21) Appl. No.: 19/339,360

(22) Filed: Sep. 25, 2025

(30) Foreign Application Priority Data
Oct. 8, 2024 (TW) 113138246

(51) Int. Cl. B01D 53/04; B01D 53/92

(52) U.S. Cl. CPC B01D 53/0462; B01D 53/0438; B01D 53/92; B01D 2257/708; B01D 2259/40009

(57) ABSTRACT

A volatile organic exhaust gas purification treatment device and a purification treatment method thereof. In the device, a case body communicates with a heat exchange unit through a pipeline. Since a position of organic exhaust gas being introduced into the heat exchange unit from a cold-side bypass pipe is a channel disposed between a front-section pipe and a rear-section pipe, a temperature of the organic exhaust gas in the channel is lower than a temperature output in the rear-section pipe, and a pressure difference is smaller. This enables an opening degree of a control valve to be controlled stably, ensuring that the organic exhaust gas is stably introduced into the channel from the cold-side bypass pipe and the front-section pipe and uniformly mixed, and avoiding structural damage to a structural material of the rear-section pipe due to excessively high airflow temperature.

### CROSS-REFERENCE TO RELATED APPLICATION

This non-provisional application claims priority under 35 U.S.C. § 119(a) on Patent Application No(s). 113138246 filed in Taiwan, R.O.C. on Oct. 8, 2024, the entire contents of which are hereby incorporated by reference.

### BACKGROUND OF THE INVENTION

### 1. Field of the Invention

The present disclosure relates to purification treatment of organic exhaust gas, and in particular to a volatile organic exhaust gas purification treatment device and a purification treatment method thereof.

### 2. Description of the Related Art

Volatile organic compounds (VOCs) produced in industrial processes, such as exhaust gas produced by the use of organic solvents in semiconductor manufacturing processes, must undergo purification treatment. For example, organic exhaust gas is passed through a concentrator for adsorption and desorption processes to concentrate the exhaust gas, and then sent to an incinerator for combustion and purification into water and carbon dioxide before discharge, so as to avoid environmental pollution.

In existing volatile organic exhaust gas purification treatment devices, organic exhaust gas is passed through a heat exchanger to reach a preheating temperature (approximately between 500° C. and 580° C.), and then sent to an incinerator for combustion and purification. However, if the temperature of the organic exhaust gas discharged from the heat exchanger cannot be controlled, leading to excessive temperature (e.g., the preheating temperature rises above 600° C.), in this case, not only will the airtight materials and structure of the burner head of the incinerator be damaged, but also the structure of the heat exchanger, such as the locking bolts used in flange assembly, will still experience thermal deformation and reduced yield stress due to over-temperature, even if fire-resistant steel capable of withstanding temperatures up to 600° C. is used, leading to the heat exchanger being prone to structural damage.

To solve the above problems, the prior art adopts a cold-side gas bypass method: low-temperature organic exhaust gas is mixed with high-temperature organic exhaust gas after heat exchange for cooling, and the mixture is then sent to an incinerator for purification treatment. However, in practice, it has been found that the position where the heat exchanger communicates with the bypass pipeline is in the section where the organic exhaust gas reaches the preheating temperature and is ready to be sent to the incinerator. At this point, the bypass pipeline is located at the output end of the heat exchanger, and the high temperature of the preheating temperature causes a large pressure difference. This makes it difficult to control the output flow of the organic exhaust gas to a stable level, resulting in an ineffective reduction of the temperature of the organic exhaust gas sent from the heat exchanger to the incinerator. At this time, the heat exchanger remains prone to the aforementioned structural damage.

Therefore, how to solve the problems of the prior art mentioned above is the main focus of the present disclosure.

### BRIEF SUMMARY OF THE INVENTION

To solve the above problems, the inventors provide a volatile organic exhaust gas purification treatment device and a purification treatment method thereof, which can stably control organic exhaust gas introduced into a heat exchange unit through a cold-side bypass pipe, ensuring that the organic exhaust gas passing through the heat exchange unit can be effectively cooled before being discharged.

To achieve the above objective, the present disclosure provides a volatile organic exhaust gas purification treatment device, including a case body, a heat exchange unit, and a cold-side bypass pipe, where the case body has a heat exchange chamber, and has an air inlet and an air outlet communicating with the heat exchange chamber, where a heat source is introduced into the heat exchange chamber through the air inlet and discharged from the air outlet; the heat exchange unit is disposed in the case body and located in the heat exchange chamber, the heat exchange unit includes a housing arranged with a front-section pipe and a rear-section pipe, each in a U-shape, and a heat absorption structure is arranged outside the front-section pipe and the rear-section pipe, where both ends of the front-section pipe are respectively provided with a first air inlet end and a first air outlet end, while both ends of the rear-section pipe are respectively provided with a second air inlet end and a second air outlet end, the first air inlet end is connected and communicates with an exhaust gas input pipe, the first air outlet end and the second air inlet end communicate with each other within a channel formed in the housing, and the second air outlet end is connected to an exhaust gas output pipe; and organic exhaust gas enters the front-section pipe through the first air inlet end via the exhaust gas input pipe, is introduced into the channel through the first air outlet end, then enters the rear-section pipe through the second air inlet end, and is output from the exhaust gas output pipe after passing through the second air outlet end; and the cold-side bypass pipe has a first end connected and communicating with the exhaust gas input pipe, and has a second end connected to the housing and directly communicating with the channel, where at least one of the cold-side bypass pipe and the exhaust gas input pipe is provided with a control valve, and when an airflow temperature of the organic exhaust gas from the exhaust gas output pipe is measured to be higher than a set threshold, the control valve is opened, so that a portion of the organic exhaust gas in the exhaust gas input pipe is directly introduced into the channel through the cold-side bypass pipe and mixed with the organic exhaust gas introduced into the channel from the first air outlet end, enabling the organic exhaust gas to be pre-cooled when passing through the rear-section pipe to keep the airflow temperature not higher than the set threshold.

In an embodiment, the device further includes a concentration unit, where the concentration unit is provided with an adsorption zone and a desorption zone; in a first stage, the organic exhaust gas passes through the adsorption zone, is adsorbed onto an adsorbent at normal temperature, and then is purified and discharged; and in a second stage, the organic exhaust gas passes through the desorption zone, is mixed with preheated air to concentrate and desorb an organic compound, and then enters the heat exchange unit from the exhaust gas input pipe for heat exchange.

In an embodiment, the heat exchange unit further includes a first preheating pipe in a U-shape and having a third air inlet end and a third air outlet end, a desorption air inlet pipe is connected between the third air outlet end and the desorption zone of the concentration unit, and the organic exhaust gas enters the first preheating pipe from the third air inlet end, is preheated to a first temperature, then is introduced into the desorption air inlet pipe and passes through the desorption zone.

In an embodiment, the heat exchange unit further includes a second preheating pipe in a U-shape and having a fourth air inlet end and a fourth air outlet end, the fourth air inlet end and the fourth air outlet end are connected in parallel to a middle section of the exhaust gas input pipe, and when the organic exhaust gas enters the exhaust gas input pipe, it first enters the second preheating pipe from the fourth air inlet end, is preheated to a second temperature, and flows out through the fourth air outlet end, and then is introduced into the first air inlet end after returning to the exhaust gas input pipe.

In an embodiment, the device further includes an incineration unit located in a combustion chamber disposed in the case body, where the exhaust gas output pipe and the air inlet communicate with each other in the combustion chamber, the organic exhaust gas enters the combustion chamber from the exhaust gas output pipe, and a contained organic compound is incinerated and purified into high-temperature gas by the incineration unit, and the high-temperature gas serves as the heat source, passes through the heat exchange chamber via the air inlet, and exchanges heat with the heat exchange unit.

In an embodiment, a flow guiding portion for guiding a direction of airflow is disposed at a position of the cold-side bypass pipe leading to the channel, and the organic exhaust gas entering the channel from the cold-side bypass pipe is guided by the flow guiding portion to at least one of the first air outlet end and the second air inlet end, so that the organic exhaust gas with lower temperature introduced by the cold-side bypass pipe and the organic exhaust gas with higher temperature introduced from the first air outlet end within the channel are uniformly mixed for effective cooling, and then discharged into the rear-section pipe from the second air inlet end.

In an embodiment, the flow guiding portion is a movable part disposed at the second end of the cold-side bypass pipe, and the flow guiding portion is optionally oriented toward the second air inlet end.

In an embodiment, the heat exchange unit has a flow guiding wall disposed obliquely above the first air outlet end within the channel, and a position of the second end of the cold-side bypass pipe directly communicating with the channel is located above the second air inlet end, and the organic exhaust gas with higher temperature introduced into the channel from the first air outlet end is guided by the flow guiding wall to flow toward the second end of the cold-side bypass pipe, so as to be uniformly mixed with the organic exhaust gas with lower temperature introduced into the channel from the second end for effective cooling, and then introduced into the rear-section pipe from the second air inlet end.

The present disclosure further provides a purification treatment method for the aforementioned volatile organic exhaust gas purification treatment device, including the following steps: exhaust gas preheating: allowing the heat source to exchange heat with the heat absorption structure through the heat exchange chamber, so as to preheat the organic exhaust gas flowing through the front-section pipe; overheating detection: detecting an airflow temperature of the organic exhaust gas output from the exhaust gas output pipe and comparing with the set threshold, and when the detected airflow temperature is not higher than the set threshold, closing the control valve, preheating all of the organic exhaust gas through the front-section pipe, and then introducing the organic exhaust gas into the rear-section pipe from the first air outlet end via the channel for purification of a contained organic compound; and overheating cooling: when the detected airflow temperature is higher than the set threshold, opening the control valve, and controlling an opening degree of the control valve according to a difference between the airflow temperature and the set threshold, so that a portion of the organic exhaust gas in the exhaust gas input pipe flowing toward the first air inlet end and not preheated by the front-section pipe directly is directly introduced into the channel from the cold-side bypass pipe, and mixed with the organic exhaust gas introduced into the channel from the first air outlet end, enabling the organic exhaust gas within the channel to be cooled and then introduced into the rear-section pipe for purification of a contained organic compound.

In an embodiment, the opening degree of the control valve is 25% to 75%.

Thus, the volatile organic exhaust gas purification treatment device and the purification treatment method thereof of the present disclosure can ensure that the organic exhaust gas passing through the front-section pipe and the cold-side bypass pipe is stably introduced into the channel and uniformly mixed. This ensures that the heat exchange unit does not experience thermal deformation or reduced yield stress due to the over-temperature of the organic exhaust gas passing through it, thereby effectively extending the service life of the purification treatment device and the heat exchange unit thereof.

### BRIEF DESCRIPTION OF THE DRAWINGS

FIG. 1 is a schematic diagram of a system architecture according to a first embodiment of the present disclosure.

FIG. 2 is an enlarged view of a case body, a heat exchange unit, and a cold-side bypass pipe in FIG. 1.

FIG. 3 is an enlarged perspective schematic view of a concentration unit in FIG. 1.

FIG. 4 is a schematic diagram showing that a cold-side bypass pipe is provided with a flow guiding portion at a second end and communicates with a channel according to a first embodiment of the present disclosure.

FIG. 5 is a flowchart of a volatile organic exhaust gas purification treatment method according to a specific embodiment of the present disclosure.

FIG. 6 is a schematic diagram of a system architecture according to a second embodiment of the present disclosure.

FIG. 7 is a schematic diagram of a system architecture according to a third embodiment of the present disclosure.

FIG. 8 is a schematic diagram of a system architecture according to a fourth embodiment of the present disclosure.

FIG. 9 is a schematic diagram of a system architecture according to a fifth embodiment of the present disclosure.

FIG. 10 is a schematic diagram of a system architecture according to a sixth embodiment of the present disclosure.

### DETAILED DESCRIPTION OF THE INVENTION

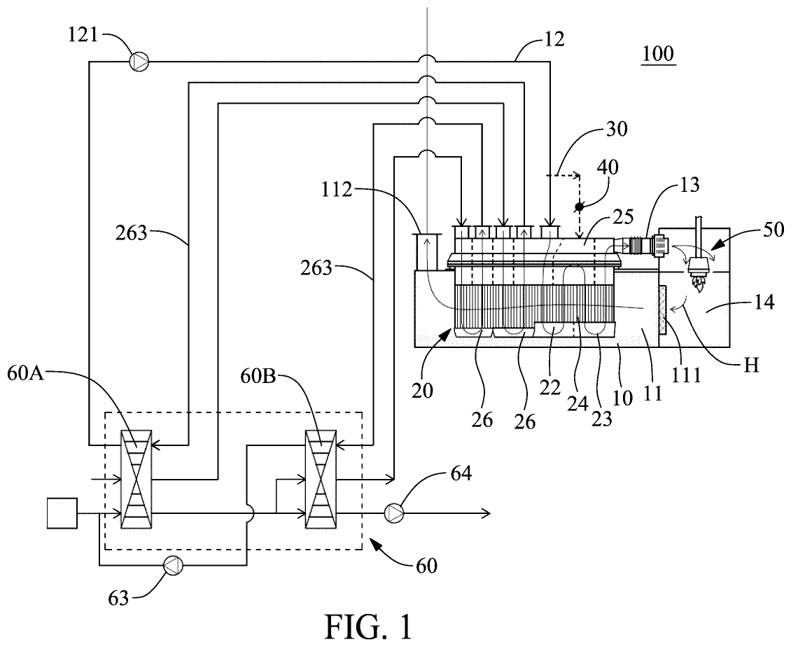

To fully understand the objectives, features, and effects of the present disclosure, the present disclosure will be described in detail below through the following specific embodiments and in conjunction with the accompanying drawings, as follows:
Please refer to FIGS. 1 to 10. The present disclosure provides a volatile organic exhaust gas purification treatment device 100. The volatile organic exhaust gas mainly refers to gases volatilized from organic solvents, which are commonly found in industrial process environments such as the electronics industry, surface coating industry, packaging material printing industry, adhesive tape industry, copper clad laminate industry, PU/PVC leather industry, and petrochemical industry. Since the contained volatile organic compounds (VOCs) are toxic and harmful to the human body, purification treatment is necessary.

The volatile organic exhaust gas purification treatment device 100 of the present disclosure, as shown in FIGS. 1 to 4, is a first embodiment, including a case body 10, a heat exchange unit 20, and a cold-side bypass pipe 30, where:

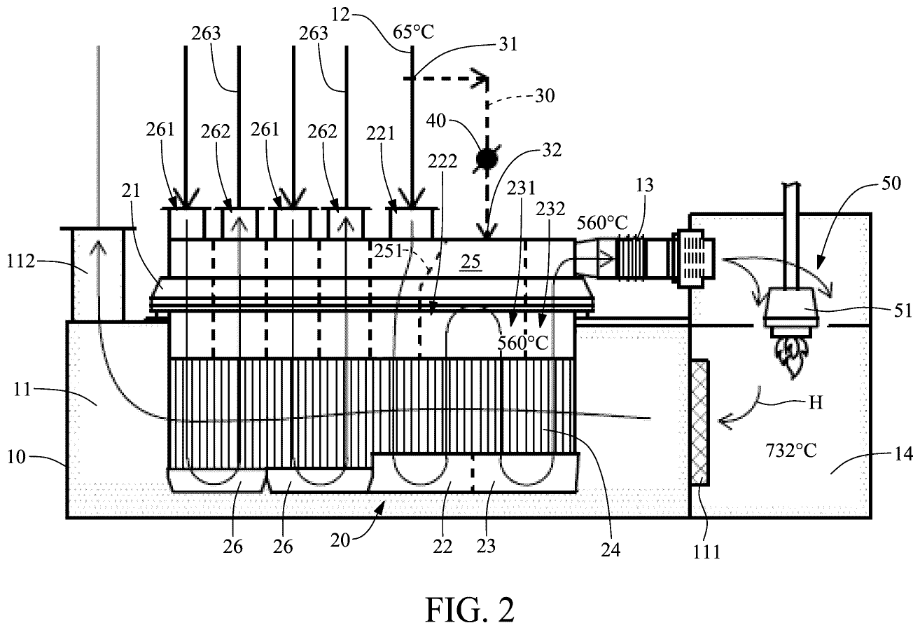

As shown in FIGS. 1 and 2, the case body 10 has a heat exchange chamber 11, and has an air inlet 111 and an air outlet 112 communicating with the heat exchange chamber 11. A heat source H is introduced into the heat exchange chamber 11 through the air inlet 111 and discharged from the air outlet 112. In an embodiment, the case body 10 is provided with a combustion chamber 14 adjacent to the heat exchange chamber 11.

As shown in FIGS. 1 and 2, the heat exchange unit 20 is disposed on the case body 10 and located in the heat exchange chamber 11. The heat exchange unit 20 includes a housing 21. In the housing 21, a front-section pipe 22 and a rear-section pipe 23 are arranged, each in a U-shape, and a heat absorption structure 24 is arranged outside the front-section pipe 22 and the rear-section pipe 23. This heat absorption structure 24 mentioned herein is composed of, for example, a metal plate, a tube bundle, a finned tube, or a fin, and in this embodiment, it is a stainless steel tube. When the heat source H passes through the heat exchange chamber 11, heat energy is transferred to the front-section pipe 22 and the rear-section pipe 23 (where the heat absorption structure is located) through the heat absorption structure 24, so as to preheat the gas passing through the front-section pipe 22 and the rear-section pipe 23. In an embodiment, as shown in FIG. 2, during the process where the heat source H passes through the heat exchange chamber 11 from the air inlet 111 and is then discharged through the air outlet 112, the heat source sequentially passes through the rear-section pipe 23, the front-section pipe 22, and two first preheating pipes 26. That is, the temperature of the heat source H is the highest when it passes through the rear-section pipe 23, and then after heat is absorbed by the front-section pipe 22 and the first preheating pipe 26 (the first one), the temperature of the heat source is the lowest when it passes through the second first preheating pipe 26.

As shown in FIG. 2, the front-section pipe 22 has a first air inlet end 221 and a first air outlet end 222 at its two ends, respectively; the rear-section pipe 23 has a second air inlet end 231 and a second air outlet end 232 at its two ends, respectively. A channel 25 is formed inside the housing 21 (as shown in FIG. 2), and the first air outlet end 222 and the second air inlet end 231 communicate with each other within the channel 25. Furthermore, the first air inlet end 221 is connected and communicates with an exhaust gas input pipe 12, and the second air outlet end 232 is connected to an exhaust gas output pipe 13. The organic exhaust gas enters the front-section pipe 22 through the first air inlet end 221 via the exhaust gas input pipe 12. A fan 121 is disposed midway on the exhaust gas input pipe 12 to assist the flow of airflow. Moreover, the gas is introduced into the channel 25 through the first air outlet end 222, then enters the rear-section pipe 23 through the second air inlet end 231, and is discharged through the exhaust gas output pipe 13 after passing through the second air outlet end 232.

As shown in FIG. 2, the cold-side bypass pipe 30 has a first end 31 that is connected and communicates with the exhaust gas input pipe 12, and has a second end 32 that is connected to the housing 21 and directly communicates with the channel 25. At least one of the cold-side bypass pipe 30 and the exhaust gas input pipe 12 is provided with a control valve 40. In an embodiment, as shown in FIG. 2, the control valve 40 is disposed on the cold-side bypass pipe 30. When the control valve 40 is closed, the organic exhaust gas does not pass through the cold-side bypass pipe 30; and when the control valve 40 is open, the organic exhaust gas passes through the cold-side bypass pipe 30 according to an opening degree of the control valve 40. The opening degree of the control valve 40 is, for example, between 25% and 75%, and in an embodiment, it is preferably between 40% and 60% (e.g., 50%).

When an airflow temperature of the organic exhaust gas from the exhaust gas output pipe 13 is measured to be higher than a set threshold, the control valve 40 is opened, so that a portion of the organic exhaust gas in the exhaust gas input pipe 12 (e.g., the organic exhaust gas at 65° C. as shown in FIG. 2) is directly introduced into the channel 25 through the cold-side bypass pipe 30 to mix with the organic exhaust gas introduced into the channel 25 from the first air outlet end 222 (approximately 300° C. as shown in FIG. 2), enabling the organic exhaust gas to be pre-cooled before passing through the rear-section pipe 23 to keep the airflow temperature not higher than the set threshold. In an embodiment, the set threshold can be set between 480° C. and 580° C. Assuming 560° C. is the preset value, if the temperature of the organic exhaust gas introduced from the rear-section pipe 23 into the exhaust gas output pipe 13 is higher than 560° C. (i.e., the temperature of the organic exhaust gas is higher than the preset value of the set threshold, reaching 580° C., for example), the control valve 40 is opened, so that the organic exhaust gas at 65° C. within the exhaust gas input pipe 12 to be directly introduced into the channel 25 through the cold-side bypass pipe 30, and mixed with the organic exhaust gas at approximately 300° C. introduced into the channel 25 from the front-section pipe 22 before being cooled. In this way, the temperature of the gas passing through the rear-section pipe 23 and introduced into the exhaust gas output pipe 13 can be stably maintained at 560° C. without over-temperature.

As mentioned above, assuming the same organic exhaust gas at 65° C. directly enters a side of the second air outlet end 232 or the exhaust gas output pipe 13 through the cold-side bypass pipe 30 (see also FIG. 2) and is mixed with the organic exhaust gas that has reached 580° C., due to the excessively large temperature difference between the cold and hot airflows, uneven mixing will easily lead to thermal deformation, and besides, the temperature of the organic exhaust gas passing through the rear-section pipe 23 and introduced into the exhaust gas output pipe 13 will easily exceed 600° C., which in turn results in reduced yield stress. For example, members such as the flanges used in the heat exchange unit 20 and the locking bolts for their assembly (made of fire-resistant steel that withstands temperatures up to 600° C., not shown in the figure) will experience weakened structural strength, thereby generating safety concerns about structural damage, and this is precisely the problem that the present disclosure intends to avoid.

In an embodiment, as shown in FIGS. 1 and 2, the device further includes an incineration unit 50. The location where the incineration unit 50 is disposed is in the combustion chamber 14, and the exhaust gas output pipe 13 and the air inlet 111 communicate with each other in the combustion chamber 14. The organic exhaust gas preheated through the rear-section pipe 23 enters the combustion chamber 14 through the exhaust gas output pipe 13. At this point, a fire source is provided by a burner head 51 of the incineration unit 50 to incinerate a contained organic compound, thereby purifying the gas into high-temperature gas (with a temperature up to 732° C.). This high-temperature gas then serves as the heat source H to pass through the heat exchange chamber 11 via the air inlet 111 to undergo the aforementioned heat exchange with the heat exchange unit 20.

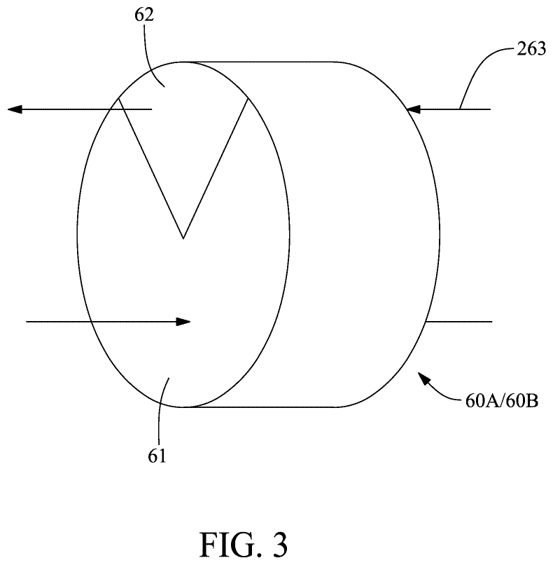

In an embodiment, as shown in FIG. 1, the device further includes a concentration unit 60. The concentration unit 60 is provided with an adsorption zone 61 and a desorption zone 62 (as shown in FIG. 3). In a first stage, the organic exhaust gas passes through the adsorption zone 61, is adsorbed onto an adsorbent at normal temperature, and then is purified and discharged. In a second stage, the organic exhaust gas passes through the desorption zone 62, is mixed with preheated air to concentrate and desorb an organic compound, and then enters the heat exchange unit 20 from the exhaust gas input pipe 12 for heat exchange.

In an embodiment, as shown in FIG. 1, the concentration unit 60 includes a rotor 60A and a rotor 60B. However, the present disclosure is not limited to dual rotors and may also use a single rotor. Furthermore, the concentration unit 60 is provided with a fan 63 and a fan 64. The fan 63 assists the organic exhaust gas in passing through the desorption zone 62 of the rotor 60B and then returning to the adsorption zone 61 of the rotor 60A. The fan 64 assists the organic exhaust gas that has passed through the adsorption zone 61 of the rotor 60A in further passing through the adsorption zone 61 of the rotor 60B.

In an embodiment, as shown in FIG. 2, the heat exchange unit 20 further includes the two first preheating pipes 26. Each first preheating pipe 26 is U-shaped and has a third air inlet end 261 and a third air outlet end 262. The two first preheating pipes 26 are respectively connected between the third air outlet end 262 and the desorption zones 62 of the rotor 60A and rotor 60B via a desorption air inlet pipe 263. The organic exhaust gas enters the first preheating pipe 26 through the third air inlet end 261, is preheated to a first temperature, and then is introduced into the desorption air inlet pipe 263 and passes through the desorption zones 62 of the rotor 60A and rotor 60B.

In an embodiment, as shown in FIG. 2, the heat exchange unit 20 has a flow guiding wall 251 disposed obliquely above the first air outlet end 222 within the channel 25. A position of the second end 32 of the cold-side bypass pipe 30 directly communicating with the channel 25 is located above the second air inlet end 231. The organic exhaust gas with higher temperature introduced into the channel 25 from the first air outlet end 222 is guided by the flow guiding wall 251 to flow toward the second end 32 of the cold-side bypass pipe 30, so as to be uniformly mixed with the organic exhaust gas with lower temperature introduced into the channel 25 from the second end 32 for effective cooling, and then introduced into the rear-section pipe 23 through the second air inlet end 231.

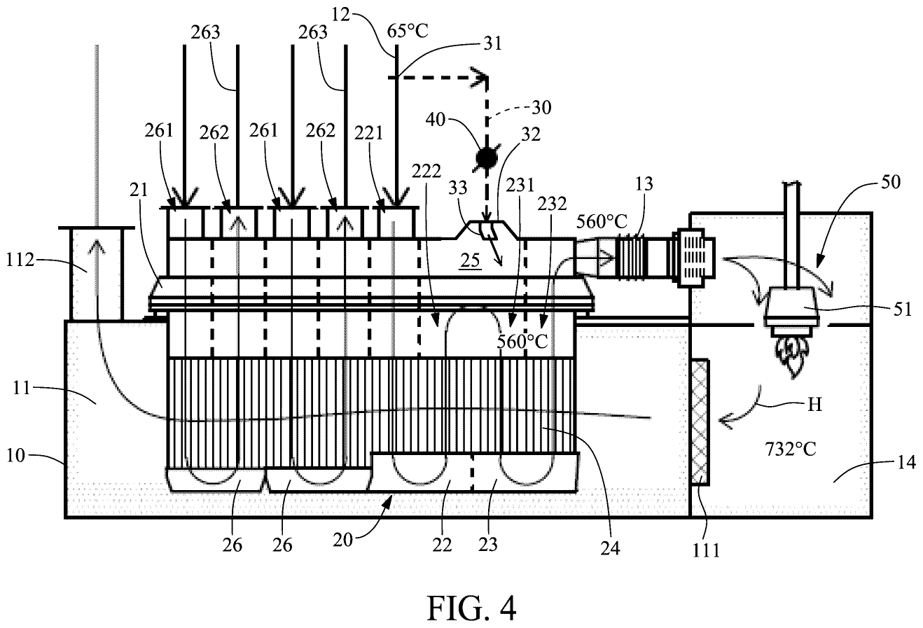

In an embodiment, as shown in FIG. 4, a flow guiding portion 33 for guiding a direction of airflow is disposed at a position of the cold-side bypass pipe 30 leading to the channel 25. The organic exhaust gas entering the channel 25 from the cold-side bypass pipe 30 is guided by the flow guiding portion 33 to at least one of the first air outlet end 222 and the second air inlet end 231, so that the organic exhaust gas with lower temperature introduced by the cold-side bypass pipe 30 and the organic exhaust gas with higher temperature introduced from the first air outlet end 222 within the channel 25 are uniformly mixed for effective cooling, and then discharged into the rear-section pipe 23 from the second air inlet end 231. In an embodiment, the flow guiding portion 33 may be a fixed part or a movable part, and is disposed at the second end 32 of the cold-side bypass pipe 30. If the flow guiding portion 33 is a movable part, it can adjust the flow direction of the organic exhaust gas introduced into the channel 25. The flow guiding portion 33 as shown in FIG. 4 is optionally oriented toward the second air inlet end 231.

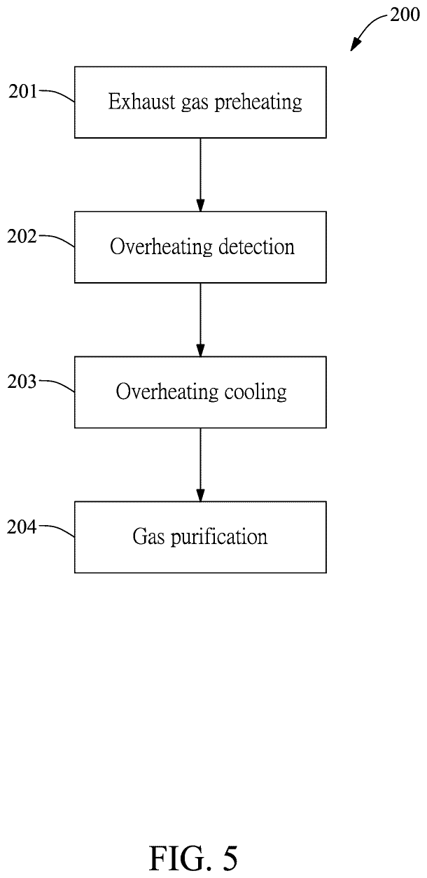

According to the aforementioned volatile organic exhaust gas purification treatment device 100, the present disclosure further provides a purification treatment method 200, including steps of exhaust gas preheating 201, overheating detection 202, overheating cooling 203, and gas purification 204, as shown in FIG. 5 (see also FIG. 2), where:

In the step of exhaust gas preheating 201, the heat source H exchanges heat with the heat absorption structure 24 through the heat exchange chamber 11, so as to preheat the organic exhaust gas flowing through the front-section pipe 22. In an embodiment, a temperature of the organic exhaust gas flowing through the exhaust gas input pipe 12 is measured to be 65° C., and after preheating by the front-section pipe 22, a temperature of the gas introduced into the channel 25 is measured to be approximately 300° C.

In the step of overheating detection 202, an airflow temperature of the organic exhaust gas output from the exhaust gas output pipe 13 is detected (e.g., by a temperature sensor) and compared with a set threshold of 560° C. When the detected airflow temperature is not higher than the set threshold, the control valve 40 is closed. All of the organic exhaust gas is preheated through the front-section pipe 22, then introduced into the rear-section pipe 23 from the first air outlet end 222 via the channel 25 for purification of a contained organic compound.

In the step of overheating cooling 203, when the detected airflow temperature of the organic exhaust gas output from the exhaust gas output pipe 13 is higher than the set threshold of 560° C., the control valve 40 is opened. The opening degree of the control valve 40 is controlled according to a difference between the airflow temperature and the set threshold (50% is used as an example here), so that a portion of the organic exhaust gas in the exhaust gas input pipe 12 flowing toward the first air inlet end 221 and not preheated by the front-section pipe 22 (with a current temperature of 65° C.) is directly introduced into the channel 25 from the cold-side bypass pipe 30, and mixed with the organic exhaust gas introduced into the channel 25 from the first air outlet end 222 (with a current temperature of approximately 300° C.), enabling the organic exhaust gas within the channel 25 to be cooled and then introduced into the rear-section pipe 23 for purification of a contained organic compound. In this embodiment, the organic exhaust gas is preheated by the rear-section pipe 23 to a temperature not higher than the set threshold of 560° C., and introduced into the combustion chamber 14 through the exhaust gas output pipe 13. The incineration unit 50 incinerates the contained organic compound to purify the gas into high-temperature gas (with a temperature up to 732° C.), and this high-temperature gas is then introduced into the heat exchange chamber 11 through the air inlet 111 for recycling. After the step of overheating cooling 203, the step of gas purification 204 is performed. For example, the organic exhaust gas is sent to the aforementioned incineration unit 50, and is burned and purified into water and carbon dioxide before being discharged.

From the above description, it is not difficult to identify the characteristics of the present disclosure, which are as follows:
1. For the volatile organic exhaust gas purification treatment device 100 and the purification treatment method 200 thereof of the present disclosure, the cold-side bypass pipe 30 communicates with the heat exchange unit 20 via the channel 25 between the front-section pipe 22 and the rear-section pipe 23. Since the organic exhaust gas in the channel 25 is only preheated by the front-section pipe 22, its temperature is lower relative to the temperature after further preheating by the rear-section pipe 23. This results in a relatively smaller pressure difference caused by a temperature difference between the cold-side bypass pipe 30 and the channel 25, thereby enabling the opening degree of the control valve 40 to be stably controlled. Consequently, the organic exhaust gas passing through the front-section pipe 22 and the cold-side bypass pipe 30 can be stably introduced into the channel 25 and mixed uniformly. Thus, this avoids the problem of uneven mixing caused by an excessively large temperature difference between cold and hot airflows that would result from the aforementioned cold-side bypass pipe 30 directly entering the side of the second air outlet end 232 or the exhaust gas output pipe 13. Additionally, this ensures that the heat exchange unit 20 does not experience thermal deformation or reduced yield stress due to the over-temperature of the organic exhaust gas passing through it, thereby preventing the heat exchanger from being prone to structural damage and further effectively extending the service life of the heat exchange unit 20. For example, if the heat exchange unit 20 is assembled with flanges using locking bolts made of fire-resistant steel that can withstand temperatures up to 600° C. at this time, presetting the set threshold to 560° C. as mentioned earlier will prevent the flanges and locking bolts from thermal deformation and reduced yield stress due to over-temperature, thus preventing structural safety concerns and also avoiding the problem of hot gas leakage caused by airtightness damage at the flange joints.

Furthermore, if the organic exhaust gas (65° C.) flowing through the cold-side bypass pipe 30 contains droplets of high-boiling-point organic solvents, such as any one of N-methylpyrrolidone (NMP), dimethylformamide (DMF), dimethylamine (DMA) and trimethylamine (TMA), monoethanolamine (MEA), dimethyl sulfoxide (DMSO), and propylene glycol methyl ether acetate (PGMEA), other similar high-boiling-point volatile organic compounds (VOCs) that form droplets, or any combination thereof, or contains organic compounds in a viscous state, when it directly enters the second air outlet end 232 or the side of the exhaust gas output pipe 13 and is mixed with the organic exhaust gas (580° C.) therein, the organic exhaust gas with a lower temperature of 65° C. will instantly vaporize upon contact with the organic exhaust gas with a high temperature of 580° C. at the position where the cold-side bypass pipe 30 is connected to the second air outlet end 232 or the exhaust gas output pipe 13. In mild cases, this will reduce the airflow stability of the organic exhaust gas passing through the burner head 51 section. In severe cases, the rapid expansion of gas volume in the confined area will cause the temperature of the organic exhaust gas to exceed the general autoignition temperature (this general autoignition temperature is between 450° C. and 600° C.), leading to a gas explosion and thus serious industrial safety accidents. To solve this problem, in the present disclosure, the cold-side bypass pipe 30 is connected to the housing 21 at the second end 32 and directly communicates with the channel 25. The temperature of the organic exhaust gas introduced into the channel 25 from the front-section pipe 22 (approximately 300° C.) is lower than that of the organic exhaust gas introduced into the exhaust gas output pipe 13 from the rear-section pipe 23 (580° C.). This can thus reduce the temperature difference at the confluence of the organic exhaust gas and improve the airflow control capability. Furthermore, if the organic exhaust gas flowing out of the cold-side bypass pipe 30 contains organic liquid droplets or organic compounds in a viscous state, since the organic exhaust gas (65° C.) converges into the channel 25 and is mixed with the organic exhaust gas (approximately 300° C.) whose temperature is lower than the general autoignition temperature, this can greatly reduce the occurrence of the phenomenon of instantaneous vaporization of the droplets, thereby alleviating the risk of gas explosion caused by the rapid expansion of gas volume.
2. The heat exchange unit 20 may have a flow guiding wall 251 disposed obliquely above the first air outlet end 222 within the channel 25. The organic exhaust gas introduced into the channel 25 from the first air outlet end 222 can be guided to flow toward the second end 32 of the cold-side bypass pipe 30 via the flow guiding wall 251. This causes the organic exhaust gas introduced into the channel 25 from the first air outlet end 222 and the organic exhaust gas introduced into the channel 25 from the second air inlet end 231 to converge and mix thoroughly, so that when the organic exhaust gas within the channel 25 is introduced into the rear-section pipe 23, the effect of uniform mixing and effective cooling can be reliably achieved. In this way, the aforementioned problem of uneven mixing of the organic exhaust gas due to an excessively large temperature difference between cold and hot airflows can also be avoided. It can also ensure that the heat exchange unit 20 does not experience thermal deformation or reduced yield stress caused by the over-temperature of the organic exhaust gas passing through it, thereby preventing the heat exchanger from being prone to structural damage.
3. The heat exchange unit 20 may also be provided with the flow guiding portion 33 at the second end 32 of the cold-side bypass pipe 30. This flow guiding portion 33 can be a fixed part or an adjustable movable part. This allows the organic exhaust gas introduced into the channel 25 from the first air outlet end 222 to be thoroughly mixed with the lower-temperature organic exhaust gas introduced into the channel 25 from the second end 32, before entering the second air inlet end 231 of the rear-section pipe 23, which also achieves the effect of uniform mixing and effective cooling. Moreover, if the flow guiding portion 33 is a movable part, the flow direction of the organic exhaust gas introduced into the channel 25 through the cold-side bypass pipe 30 can also be adjusted. This enables more flexible application when the organic exhaust gas in the channel 25 is mixed and cooled.

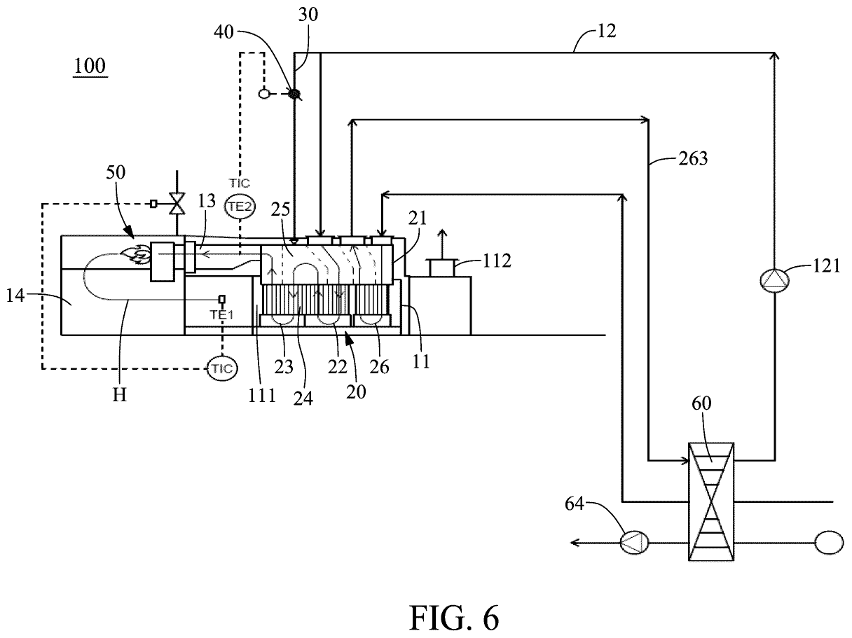

As shown in FIG. 6, this is a purification treatment device 100 of a second embodiment of the present disclosure. The main difference between this embodiment and the aforementioned first embodiment lies in that this embodiment is a simplified version of the purification treatment device 100 of the first embodiment. A concentration unit 60 in this embodiment has only one rotor, and only one first preheating pipe 26 is disposed in this embodiment. The opening and closing of a control valve 40 in this embodiment can also be controlled by the temperatures sensed by temperature sensors TE1 and TE2, where the control for the control valve 40 is the same as that described in the first embodiment, and will not be repeated here. Thus, in this embodiment, the organic exhaust gas introduced into the channel 25 from the first air outlet end 222 is at approximately 300° C., and finally, this embodiment can also achieve the effect that the organic exhaust gas output from the exhaust gas output pipe 13 is at the set threshold of 560° C.

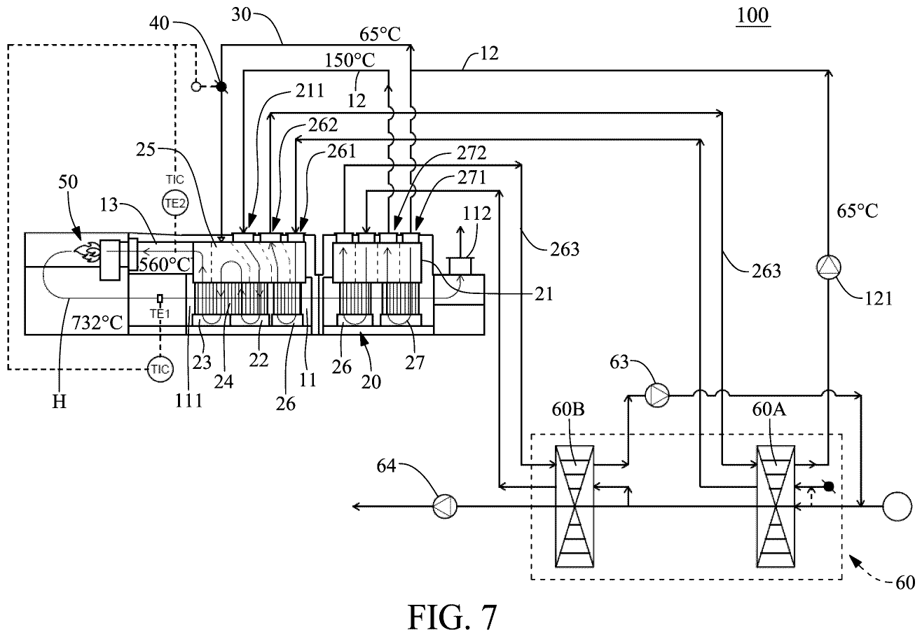

As shown in FIG. 7, this is a purification treatment device 100 of a third embodiment of the present disclosure. The main difference between this embodiment and the aforementioned first embodiment is that the heat exchange unit 20 further includes a second preheating pipe 27. The second preheating pipe 27 is U-shaped and has a fourth air inlet end 271 and a fourth air outlet end 272. The fourth air inlet end 271 and the fourth air outlet end 272 are connected in parallel to a middle section of the exhaust gas input pipe 12. When the organic exhaust gas enters the exhaust gas input pipe 12, it first enters the second preheating pipe 27 from the fourth air inlet end 271, is preheated to a second temperature, and flows out through the fourth air outlet end 272, and then is introduced into the first air inlet end 221 after returning to the exhaust gas input pipe 12. Thus, the organic exhaust gas in the exhaust gas input pipe 12 can be preheated to 150° C. after passing through the second preheating pipe 27, and is then introduced into the front-section pipe 22 from the first air inlet end 221. The organic exhaust gas introduced into the channel 25 from the first air outlet end 222 is at approximately 350° C. Therefore, this embodiment can also finally achieve the effect that the organic exhaust gas output from the exhaust gas output pipe 13 is at the set threshold of 560° C.

Furthermore, the heat exchange unit 20 is provided with a temperature sensor TE1 between the air inlet 111 and the combustion chamber 14, and a temperature sensor TE2 is arranged at the position of the exhaust gas output pipe 13. The temperature of the organic exhaust gas introduced into the heat exchange chamber 11 from the combustion chamber 14 is sensed by the temperature sensor TE1, and the temperature (TIC) of the organic exhaust gas flowing through the exhaust gas output pipe 13 is sensed by the temperature sensor TE2. At this time, the control valve 40 (in this embodiment, it is also arranged on the cold-side bypass pipe 30) is electrically connected to the temperature sensor TE1 and the temperature sensor TE2, respectively. Through the temperature sensor TE2, it can be sensed whether the temperature of the organic exhaust gas in the exhaust gas output pipe 13 exceeds the set threshold.

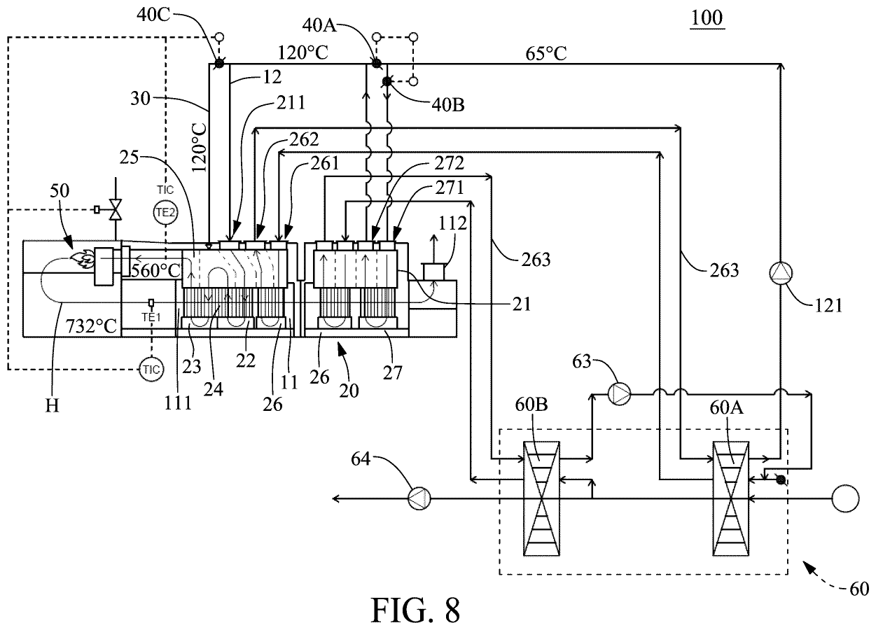

As shown in FIG. 8, this is a purification treatment device 100 of a fourth embodiment of the present disclosure. The main difference between this embodiment and the aforementioned first embodiment is that, similar to the third embodiment, the heat exchange unit 20 is also provided with a second preheating pipe 27. Moreover, in this embodiment, a control valve 40A is disposed on the main pipeline of the exhaust gas input pipe 12, and another control valve 40B is disposed on the manifold of the exhaust gas input pipe 12 that leads to the second preheating pipe 27, and a control valve 40C is also disposed on the cold-side bypass pipe 30. The opening and closing of the control valve 40A, the control valve 40B, and the control valve 40C in this embodiment can be controlled based on the temperatures sensed by the temperature sensors TE1 and TE2, where the control for the control valve 40C is the same as that for the control valve 40 described in the first embodiment, and will not be repeated here. In this embodiment, by closing the control valve 40A and opening the control valve 40B, the organic exhaust gas first passes through the second preheating pipe 27 before entering the front-section pipe 22 from the first air inlet end 221. If the control valve 40B is closed and the control valve 40A is opened, the organic exhaust gas will enter the front-section pipe 22 from the first air inlet end 221 without passing through the second preheating pipe 27. The organic exhaust gas introduced into the channel 25 from the first air outlet end 222 is at approximately 325° C. Therefore, this embodiment can also finally achieve the effect that the organic exhaust gas output from the exhaust gas output pipe 13 is at the set threshold of 560° C.

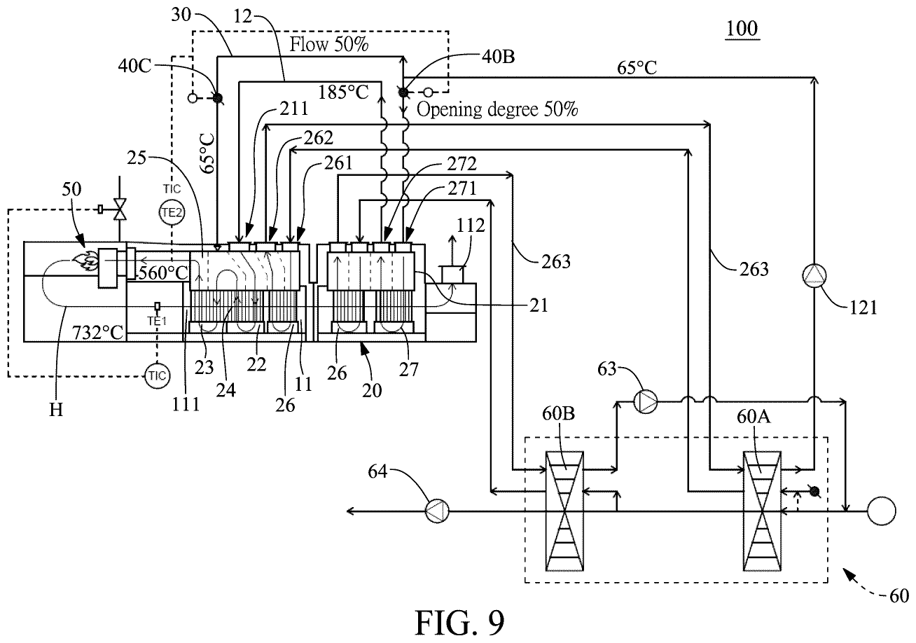

As shown in FIG. 9, this is a purification treatment device 100 of a fifth embodiment of the present disclosure. The main difference between this embodiment and the aforementioned first embodiment is that, similar to the third and fourth embodiments, the heat exchange unit 20 is also provided with a second preheating pipe 27. Moreover, in this embodiment, a control valve 40B is disposed on the manifold of the exhaust gas input pipe 12 that leads to the second preheating pipe 27, and a control valve 40C is also disposed on the cold-side bypass pipe 30. The opening and closing of the control valve 40B and the control valve 40C in this embodiment can be controlled by the temperatures sensed by the temperature sensors TE1 and TE2, where the control for the control valve 40C is the same as that for the control valve 40 described in the first embodiment, and will not be repeated here. In this embodiment, by controlling the opening degree of the control valve 40B to 50%, 50% of the flow of the organic exhaust gas passes through the second preheating pipe 27 and enters the front-section pipe 22 from the first air inlet end 221, so that the temperature of the organic exhaust gas reaches 185° C. when it enters the first air inlet end 221. Furthermore, when the control valve 40C is opened, 50% of the flow of the organic exhaust gas at 65° C. is also introduced into the channel 25 through the cold-side bypass pipe 30. The organic exhaust gas introduced into the channel 25 from the first air outlet end 222 is at approximately 365° C. Therefore, this embodiment can also finally achieve the effect that the organic exhaust gas output from the exhaust gas output pipe 13 is at the set threshold of 560° C.

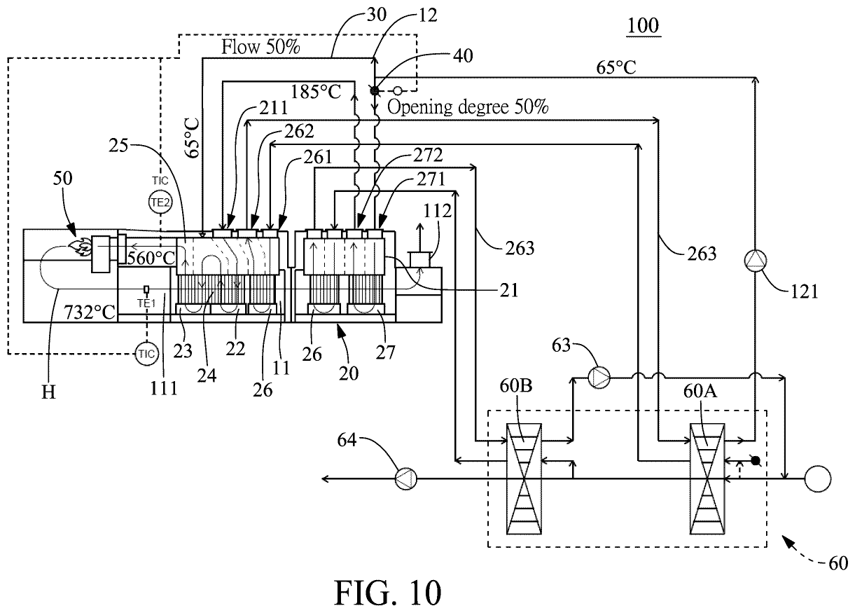

As shown in FIG. 10, this is a purification treatment device 100 of a sixth embodiment of the present disclosure, which is based on the aforementioned fifth embodiment but omits the control valve 40C in the fifth embodiment. At this time, by controlling the opening degree of the control valve 40B to 50%, 50% of the flow of the organic exhaust gas will pass through the second preheating pipe 27 and enter the front-section pipe 22 from the first air inlet end 221, so that the temperature of the organic exhaust gas reaches 185° C. when it enters the first air inlet end 221. Moreover, since no control valve 40C is arranged on the cold-side bypass pipe 30 in this embodiment, 50% of the flow of the organic exhaust gas at 65° C. is directly introduced into the channel 25. The organic exhaust gas introduced into the channel 25 from the first air outlet end 222 is at approximately 365° C. Therefore, this embodiment can also finally achieve the effect that the organic exhaust gas output from the exhaust gas output pipe 13 is at the set threshold of 560° C.

While the present disclosure has been described by means of specific embodiments, numerous modifications and variations could be made thereto by those skilled in the art without departing from the scope and spirit of the present disclosure set forth in the claims.

What is claimed is:

1. A volatile organic exhaust gas purification treatment device, comprising:
a case body having a heat exchange chamber, and having an air inlet and an air outlet communicating with the heat exchange chamber, wherein a heat source is introduced into the heat exchange chamber through the air inlet and discharged from the air outlet;
a heat exchange unit disposed in the case body and located in the heat exchange chamber, the heat exchange unit comprising a housing arranged with a front-section pipe and a rear-section pipe, each in a U-shape, and a heat absorption structure arranged outside the front-section pipe and the rear-section pipe, wherein both ends of the front-section pipe are respectively provided with a first air inlet end and a first air outlet end, while both ends of the rear-section pipe are respectively provided with a second air inlet end and a second air outlet end, the first air inlet end is connected and communicates with an exhaust gas input pipe, the first air outlet end and the second air inlet end communicate with each other within a channel formed in the housing, and the second air outlet end is connected to an exhaust gas output pipe; and organic exhaust gas enters the front-section pipe through the first air inlet end via the exhaust gas input pipe, is introduced into the channel through the first air outlet end, then enters the rear-section pipe through the second air inlet end, and is output from the exhaust gas output pipe after passing through the second air outlet end; and
a cold-side bypass pipe having a first end connected and communicating with the exhaust gas input pipe, and having a second end connected to the housing and directly communicating with the channel, wherein at least one of the cold-side bypass pipe and the exhaust gas input pipe is provided with a control valve, and when an airflow temperature of the organic exhaust gas from the exhaust gas output pipe is measured to be higher than a set threshold, the control valve is opened, so that a portion of the organic exhaust gas in the exhaust gas input pipe is directly introduced into the channel through the cold-side bypass pipe and mixed with the organic exhaust gas introduced into the channel from the first air outlet end, enabling the organic exhaust gas to be pre-cooled when passing through the rear-section pipe to keep the airflow temperature not higher than the set threshold.

2. The volatile organic exhaust gas purification treatment device according to claim 1, further comprising a concentration unit, wherein the concentration unit is provided with an adsorption zone and a desorption zone; in a first stage, the organic exhaust gas passes through the adsorption zone, is adsorbed onto an adsorbent at normal temperature, and then is purified and discharged; and in a second stage, the organic exhaust gas passes through the desorption zone, is mixed with preheated air to concentrate and desorb an organic compound, and then enters the heat exchange unit from the exhaust gas input pipe for heat exchange.

3. The volatile organic exhaust gas purification treatment device according to claim 2, wherein the heat exchange unit further comprises a first preheating pipe in a U-shape and having a third air inlet end and a third air outlet end, a desorption air inlet pipe is connected between the third air outlet end and the desorption zone of the concentration unit, and the organic exhaust gas enters the first preheating pipe from the third air inlet end, is preheated to a first temperature, then is introduced into the desorption air inlet pipe and passes through the desorption zone.

4. The volatile organic exhaust gas purification treatment device according to claim 3, wherein the heat exchange unit further comprises a second preheating pipe in a U-shape and having a fourth air inlet end and a fourth air outlet end, the fourth air inlet end and the fourth air outlet end are connected in parallel to a middle section of the exhaust gas input pipe, and when the organic exhaust gas enters the exhaust gas input pipe, it first enters the second preheating pipe from the fourth air inlet end, is preheated to a second temperature, and flows out through the fourth air outlet end, and then is introduced into the first air inlet end after returning to the exhaust gas input pipe.

5. The volatile organic exhaust gas purification treatment device according to claim 1, further comprising an incineration unit located in a combustion chamber disposed in the case body, wherein the exhaust gas output pipe and the air inlet communicate with each other in the combustion chamber, the organic exhaust gas enters the combustion chamber from the exhaust gas output pipe, and a contained organic compound is incinerated and purified into high-temperature gas by the incineration unit, and the high-temperature gas serves as the heat source, passes through the heat exchange chamber via the air inlet, and exchanges heat with the heat exchange unit.

6. The volatile organic exhaust gas purification treatment device according to claim 1, wherein a flow guiding portion for guiding a direction of airflow is disposed at a position of the cold-side bypass pipe leading to the channel, and the organic exhaust gas entering the channel from the cold-side bypass pipe is guided by the flow guiding portion to at least one of the first air outlet end and the second air inlet end, so that the organic exhaust gas with lower temperature introduced by the cold-side bypass pipe and the organic exhaust gas with higher temperature introduced from the first air outlet end within the channel are uniformly mixed for effective cooling, and then discharged into the rear-section pipe from the second air inlet end.

7. The volatile organic exhaust gas purification treatment device according to claim 6, wherein the flow guiding portion is a movable part disposed at the second end of the cold-side bypass pipe, and the flow guiding portion is optionally oriented toward the second air inlet end.

8. The volatile organic exhaust gas purification treatment device according to claim 1, wherein the heat exchange unit has a flow guiding wall disposed obliquely above the first air outlet end within the channel, and a position of the second end of the cold-side bypass pipe directly communicating with the channel is located above the second air inlet end, and the organic exhaust gas with higher temperature introduced into the channel from the first air outlet end is guided by the flow guiding wall to flow toward the second end of the cold-side bypass pipe, so as to be uniformly mixed with the organic exhaust gas with lower temperature introduced into the channel from the second end for effective cooling, and then introduced into the rear-section pipe from the second air inlet end.

9. A purification treatment method for the volatile organic exhaust gas purification treatment device according to any one of claims 1, comprising:
exhaust gas preheating: allowing the heat source to exchange heat with the heat absorption structure through the heat exchange chamber, so as to preheat the organic exhaust gas flowing through the front-section pipe;
overheating detection: detecting an airflow temperature of the organic exhaust gas output from the exhaust gas output pipe and comparing with a set threshold, and when the detected airflow temperature is not higher than the set threshold, closing the control valve, preheating all of the organic exhaust gas through the front-section pipe, and then introducing the organic exhaust gas into the rear-section pipe from the first air outlet end via the channel for purification of a contained organic compound; and
overheating cooling: when the detected airflow temperature is higher than the set threshold, opening the control valve, and controlling an opening degree of the control valve according to a difference between the airflow temperature and the set threshold, so that a portion of the organic exhaust gas in the exhaust gas input pipe flowing toward the first air inlet end and not preheated by the front-section pipe directly is directly introduced into the channel from the cold-side bypass pipe, and mixed with the organic exhaust gas introduced into the channel from the first air outlet end, enabling the organic exhaust gas within the channel to be cooled and then introduced into the rear-section pipe for purification of a contained organic compound.

10. The purification treatment method according to claim 9, wherein the opening degree of the control valve is 25% to 75%.
